(19) United States
(12) Patent Application Publication
(10) Pub. No.: US 2023/0299543 A1
(43) Pub. Date: Sep. 21, 2023

(54) LEAD MODULE, ELECTRICAL CONNECTOR, AND CONNECTOR COMPONENT

(71) Applicant: HUAWEI TECHNOLOGIES CO., LTD., Shenzhen (CN)

(72) Inventors: Congtu XIAO, Dongguan (CN); Tao YE, Dongguan (CN); Tinghe WU, Dongguan (CN); Zhengyan OU, Shenzhen (CN)

(21) Appl. No.: 18/323,621

(22) Filed: May 25, 2023

Related U.S. Application Data
(63) Continuation of application No. PCT/CN2021/098414, filed on Jun. 4, 2021.

(30) Foreign Application Priority Data
Nov. 26, 2020 (CN) 202011347517.X

(51) Int. Cl. H01R 13/6587; H01R 13/652; H01R 13/627

(52) U.S. Cl. CPC H01R 13/6587; H01R 13/652; H01R 13/627

(57) ABSTRACT

This application provides a lead module. The lead module includes a plurality of lead pairs and two shielding pieces, and the two shielding pieces each are made of a conductive material and are located parallel to each other on two sides of the plurality of lead pairs. Therefore, a ground wire or a shielding element may no longer be disposed between the two shielding pieces in the lead module of this application and between parts that are of adjacent lead pairs and that correspond to a body part of a lead, and the lead module uses the two shielding pieces as the ground wire and the shielding element. Therefore, crosstalk between the lead pairs for signal transmission is effectively reduced with a simple structure. This application further provides an electrical connector including the lead module and a connector component including the electrical connector.

### CROSS-REFERENCE TO RELATED APPLICATIONS

This application is a continuation of International Application No. PCT/CN2021/098414 filed on Jun. 4, 2021, which claims priority to Chinese Patent Application No. 202011347517.X, filed on Nov. 26, 2020. The disclosures of the aforementioned applications are hereby incorporated by reference in their entireties.

### TECHNICAL FIELD

This application relates to a structure of a connector for implementing information communication between electronic devices, and in particular, to a lead module, an electrical connector including the lead module, and a connector component including the electrical connector.

### BACKGROUND

In today's electrical connectors for implementing information communication between electronic devices, crosstalk performance between lead pairs for signal transmission has significant impact on high-speed link transmission performance of the electrical connectors. When signal transmission at a high rate of 56 Gbit/s or higher needs to be implemented, a wire connection layout inside the electrical connector has become essential to affecting performance of the electrical connector, and further affects the crosstalk performance between the lead pairs of the electrical connector.

A typical high-speed electrical connector is a differential connector. In this differential connector, two signals, namely, a P signal and an N signal, are transmitted through a lead pair. The P and N signals need to be transmitted from a mutual configuration interface of the differential connector to a pin position through the lead pair. Usually, in this differential connector, a ground wire is disposed between adjacent lead pairs.

For example, FIG. 1A is a schematic diagram of a partial sectional view of an example of an existing electrical connector. As shown in FIG. 1A, the electrical connector includes a lead 10, a ground wire 20, an insulator 30, and a substrate 40. The lead 10 and the ground wire 20 are each made of a conductive material, the substrate 40 includes a conductive material, and the insulator 30 is made of a non-conductive insulation material. The lead 10 and the ground wire 20 are arranged in a same position in an up-down direction in 1A, the lead 10 and the ground wire 20 are embedded in the insulator 30, the insulator 30 is located on a side of the substrate 40 and fastened to the substrate 40, and the substrate 40 is also grounded. In addition, two adjacent leads 10 form a lead pair, and one ground wire 20 is arranged between adjacent lead pairs. In this way, a signal can be transmitted in the electrical connector through the lead pair, but it is found by testing that the ground wire 20 causes increased crosstalk between two adjacent lead pairs.

FIG. 1B is a schematic diagram of a partial sectional view of another example of an existing electrical connector. As shown in FIG. 1B, the electrical connector includes a lead 10, a ground wire 20, and a shielding housing 50. The lead 10 and the ground wire 20 are each made of a conductive material, and the shielding housing 50 is at least partially made of a conductive material. The lead 10 and the ground wire 20 are arranged in a same position in an up-down direction in FIG. 1B. Two adjacent leads 10 form a lead pair, each lead pair is arranged in the shielding housing 50, and the shielding housing 50 is connected to ground wires 20 on two sides of the lead pair and completely surrounds the lead pair inside. Although an ability of the shielding housing 50 to greatly reduce crosstalk between the lead pairs counteracts negative impact brought by the ground wire 20 in increasing the crosstalk between the lead pairs, use of such an all-round shielding housing 50 results in a significant increase in costs of the electrical connector and is unfavorable to large-scale industrial production.

### SUMMARY

In view of this, a lead module is provided, and the lead module can effectively reduce crosstalk between lead pairs for signal transmission while reducing costs. An electrical connector including the lead module and a connector component including the electrical connector are further provided. The electrical connector and the connector component implement same technical effect by using the lead module of the present invention.

Therefore, the following technical solutions are used in this application.

According to a first aspect, an embodiment of this application provides a lead module, and the lead module includes:

a plurality of lead pairs, where each lead pair includes two leads parallel to each other, two adjacent lead pairs are spaced apart by a predetermined distance, each lead includes a pin end part, a contact end part, and a body part, and the body part is between the pin end part and the contact end part; and

two shielding pieces, where the two shielding pieces each include a conductive material, the two shielding pieces are parallel to each other, the plurality of lead pairs are sandwiched between the two shielding pieces, and the plurality of lead pairs are fastened relative to the two shielding pieces.

According to the foregoing technical solution, in the lead module of the application, the shielding pieces on two sides of the lead pair are used as a ground wire and a shielding element, so that the ground wire or the shielding element is no longer disposed between the two shielding pieces and between body parts of the leads. Therefore, crosstalk between the lead pair for signal transmission is effectively reduced with a simple structure.

According to the first aspect, in a first possible implementation of the lead module, the plurality of lead pairs are laid between the two shielding pieces in a direction perpendicular to a surface of either of the two shielding pieces.

According to the foregoing technical solution, the lead module can be implemented with a simple structure, and a size of the lead module in a thickness direction can be reduced.

According to a first possible implementation of the first aspect, the lead module further includes at least one fastening member made of a non-conductive insulation material, the fastening member is located between the two shielding pieces and fastened to the two shielding pieces, and a part of the body part of each lead is embedded in the fastening member, so that the plurality of lead pairs are fastened relative to the two shielding pieces by using the fastening member.

According to the foregoing technical solution, relative fastening between the lead pair and the shielding piece can be implemented with a simple structure, and signal transmission in the lead pair is not affected.

According to the first aspect or any possible implementation of the first aspect, in the plurality of lead pairs, the body part of each lead includes an embedded part embedded in the fastening member and an exposed part other than the embedded part, so that in the plurality of lead pairs, at least a part of a surface that is of each exposed part and that faces a same shielding piece is located in a first plane, and the first plane is parallel to a plane in which a surface of either of the two shielding pieces is located.

According to the foregoing technical solution, a structure layout of the lead module can be simpler, and a size of the lead module in a thickness direction can be further reduced.

According to the first aspect or any possible implementation of the first aspect, in the direction perpendicular to a surface of either of the two shielding pieces, distances between the exposed parts of each lead and each of the two shielding pieces are equal.

According to the foregoing technical solution, a structure layout of the lead module can be simpler, and a size of the lead module in a thickness direction can be further reduced.

According to the first aspect or any possible implementation of the first aspect, in the direction perpendicular to a surface of either of the two shielding pieces, a spacing between the two shielding pieces is D1, and

in two adjacent lead pairs, if a minimum distance between exposed parts of two adjacent leads that are respectively located in different lead pairs is D2,

D1<D2 is satisfied.

According to the foregoing technical solution, shielding effect of the two shielding pieces can be improved, and crosstalk between the lead pairs can be further reduced.

According to the first aspect or any possible implementation of the first aspect, 0.6 mm≤D1≤1.1 mm; and/or 1.1 mm≤D2≤1.5 mm.

According to the foregoing technical solution, crosstalk between the lead pairs can be further reduced in some specific application apparatuses (for example, a router).

According to the first aspect or any possible implementation of the first aspect, in each lead pair, a minimum distance between exposed parts of two leads is D3, and

if a minimum distance between the exposed part of each lead and an inner surface of either of the two shielding pieces is D4,

D3<D4 is satisfied.

According to the foregoing technical solution, crosstalk between the lead pairs can be further reduced.

According to the first aspect or any possible implementation of the first aspect, 0.2 mm≤D3≤0.25 mm; and/or 0.3 mm≤D4≤0.4 mm.

According to the foregoing technical solution, crosstalk between the lead pairs can be further reduced in some specific application apparatuses (for example, a router).

According to the first aspect or any possible implementation of the first aspect, for each lead, a length of the exposed part is greater than a length of the embedded part.

According to the foregoing technical solution, an insertion loss caused by embedding the lead pair into an insulator can be effectively reduced, and an insertion loss of a signal in the lead pair during long-distance transmission can be reduced.

According to the first aspect or any possible implementation of the first aspect, for each lead, the length of the exposed part is greater than or equal to three times the length of the embedded part.

According to the foregoing technical solution, an insertion loss of the lead pair can be further effectively reduced.

According to the first aspect or any possible implementation of the first aspect, the fastening member has protrusion parts protruding toward the two shielding pieces, the two shielding pieces each have a mounting hole matching the protrusion part, and the fastening member is mounted and fastened to the two shielding pieces through fit installation between the protrusion part and the mounting holes; or the two shielding pieces each have a protrusion part protruding toward the fastening member, the fastening member has a mounting hole matching the protrusion parts, and the fastening member is mounted and fastened to the two shielding pieces through fit installation between the protrusion parts and the mounting holes.

According to the foregoing technical solution, effective relative fastening between the lead pair and the shielding piece can be implemented with a simple structure.

According to the first aspect or any possible implementation of the first aspect, pin end parts of all leads together form a pin part of the lead module, and contact end parts of all leads together form a contact part of the lead module, and an angle formed by the contact part and the pin part is changed by changing an extension direction of the lead.

According to the foregoing technical solution, two ends of the lead pair in the lead module in this application can form any desired angle, so that the lead module in this application can be more widely applied.

According to the first aspect or any possible implementation of the first aspect, a shielding piece pin part is disposed at a part that is of the shielding piece and that is adjacent to the pin part, and the shielding piece pin part and the pin part together form the pin part of the lead module, and a shielding piece contact part is disposed at a part that is of the shielding piece and that is adjacent to the contact part, and the shielding piece contact part and the contact part together form the contact part of the lead module.

According to the foregoing technical solution, the shielding piece has a structure of the shielding piece pin part and the shielding piece contact part that match the lead pair, to ensure a connection between the lead module and an external structure.

According to the first aspect or any possible implementation of the first aspect, the lead module further includes a plurality of additional shielding piece components, the plurality of additional shielding piece components are inserted between the two shielding pieces and fastened relative to the two shielding pieces, and the plurality of additional shielding piece components are alternately arranged with contact parts of the plurality of lead pairs, so that the additional shielding piece components are disposed on two sides of the contact part of any lead pair.

According to the foregoing technical solution, shielding effect at the contact part can be improved, and crosstalk between the lead pairs at the contact part can be further reduced.

According to a second aspect, this application provides an electrical connector, and the electrical connector includes one or more lead modules according to the first aspect or any possible implementation of the first aspect.

According to the foregoing technical solution, the electrical connector has same effect as the lead module.

According to the second aspect, in a first possible implementation of the electrical connector, the plurality of lead modules are arranged in a stacked manner in which shielding pieces of all the lead modules are parallel.

According to the foregoing technical solution, the electrical connector can be constructed in a simple manner by using the lead module of the application.

According to the second aspect or any possible implementation of the second aspect, pin parts of all the lead modules are arranged in a matrix manner, to form a pin part of the connector; and contact parts of all the lead modules are arranged in a matrix manner, to form a contact part of the connector.

According to the foregoing technical solution, the pin part of the connector and the contact part of connector of the electrical connector can be constructed in a simple manner by using the pin part and the contact part of the lead module of the application.

According to the second aspect or any possible implementation of the second aspect, adjacent lead modules share one shielding piece.

According to the foregoing technical solution, a structure of the electrical connector can be further simplified.

According to the second aspect or any possible implementation of the second aspect, the electrical connector further includes a fastening frame, and the fastening frame is assembled with the plurality of lead modules, so that the plurality of lead modules are relatively fastened.

According to the foregoing technical solution, a plurality of lead modules can be stably fastened together with a simple structure.

According to a third aspect, this application provides a connector component, and the connector component includes the electrical connector according to the second aspect or any possible implementation of the second aspect and an interconnection electrical connector capable of matching and being connected to the electrical connector.

According to the foregoing technical solution, the electrical connector has same effect as the lead module and the electrical connector.

According to the third aspect, in a first possible implementation of the connector component, the electrical connector and the interconnection electrical connector are respectively disposed on two circuit boards disposed perpendicularly to each other.

According to the foregoing technical solution, the electrical connector according to this application may be applied to structure layouts of various circuit boards.

According to the third aspect or any possible implementation of the third aspect, after the electrical connector and the interconnection electrical connector are connected, the connector component can implement signal transmission at a rate of at least 56 Gbps.

According to the foregoing technical solution, the electrical connector according to this application may be applied to a scenario of high-speed signal transmission.

According to the foregoing technical solutions, the solutions of this application can be more widely applied.

These aspects and other aspects of this application are more concise and easier to understand in descriptions of the following (a plurality of) embodiments.

### BRIEF DESCRIPTION OF DRAWINGS

Accompanying drawings included in this specification and constituting a part of this specification and this specification jointly show example embodiments, features, and aspects of this application, and are intended to explain principles of this application.

FIG. 1A is a schematic diagram of a partial sectional view of an example of an existing electrical connector; and FIG. 1B is a schematic diagram of a partial sectional view of another example of an existing electrical connector.

FIG. 2A is a schematic three-dimensional diagram of a lead module according to a first example embodiment of this application; FIG. 2B is a schematic main view of the lead module in FIG. 2A; FIG. 2C is a schematic exploded view of the lead module in FIG. 2A; FIG. 2D is a schematic diagram of a sectional view of the lead module in FIG. 2A; FIG. 2E is a schematic diagram of a structure of two lead pairs and two fastening members of the lead module in FIG. 2A in an assembled state; FIG. 2F is a schematic top view of the lead pair and the fastening member in FIG. 2E; FIG. 2G is a schematic three-dimensional diagram of two lead pairs of the lead module in FIG. 2A; and FIG. 2H is a partially enlarged schematic diagram of the structure in FIG. 2A.

FIG. 3 is a schematic three-dimensional diagram of an electrical connector including a plurality of lead modules shown in FIG. 2A.

FIG. 4A is a schematic three-dimensional diagram of a lead module according to a second example embodiment of this application; FIG. 4B is a schematic exploded view of the lead module in FIG. 4A; FIG. 4C is a schematic diagram of a structure of a plurality of lead pairs and an integrated fastening member of the lead module in FIG. 4A in an assembled state; FIG. 4D is a partially enlarged schematic diagram of the structure in FIG. 4C; FIG. 4E is a schematic three-dimensional diagram of the integrated fastening member of the lead module in FIG. 4A; FIG. 4F is a schematic three-dimensional diagram of the plurality of lead pairs of the lead module in FIG. 4A; FIG. 4G is an enlarged schematic diagram of a partial structure of a lead pair of the lead module in FIG. 4A, showing pin end parts of the lead pair; FIG. 4H is an enlarged schematic diagram of a partial structure of a lead pair of the lead module in FIG. 4A, showing contact end parts of the lead pair; FIG. 4I is a schematic three-dimensional diagram of a first shielding piece of the lead module in FIG. 4A; FIG. 4J is a partially enlarged schematic diagram of a region S of the first shielding piece in FIG. 4I; FIG. 4K is another schematic exploded view of the lead module in 4A; FIG. 4L is a schematic three-dimensional diagram of a structure of an additional shielding component of the lead module in 4A; and FIG. 4M is a schematic exploded view of the additional shielding component in FIG. 4L.

FIG. 5A is a schematic three-dimensional diagram of an electrical connector including a plurality of lead modules shown in FIG. 4A; and FIG. 5B is a schematic exploded view of the electrical connector in FIG. 5A.

FIG. 6A is a schematic diagram of a three-dimensional structure of a connector component according to an example of this application; and FIG. 6B is a schematic diagram of a three-dimensional structure of a connector component according to another example of this application.

### DESCRIPTION OF REFERENCE NUMERALS

10: Lead; 20: Ground wire; 30: Insulator; 40: Substrate; 50: Shielding housing;
M: Lead module; 1: Lead; 11: Body part; 11a: First lead segment; 11b: Second lead segment; 12: Pin end part; 13: Contact end part; la: First lead pair; 1b: Second lead pair; 1c: Third lead pair; 1d: Fourth lead pair; 1e: Fifth lead pair; 1f: Sixth lead pair; 1g: Seventh lead pair; 1h: Eighth lead pair; 1i: Ninth lead pair; 1j: Tenth lead pair; 1k: Eleventh lead pair; 1m: Twelfth lead pair;
2a: First shielding piece; 2a1: First mounting hole; 2a2: First shielding piece pin part; 2a3: First shielding piece contact part; 2b: Second shielding piece; 2b1: Second mounting hole; 2b2: Second shielding piece pin part; 2b3: Second shielding piece contact part;
3a: First fastening member; 3a1: First body part; 3a2: First protrusion part; 3b: Second fastening member; 3b1: Second body part; 3b2: Second protrusion part; 3c: Integrated fastening member; 3c1: Protrusion part; 3c2: Horizontal rib part; 3c3: Vertical rib part;
4: Additional shielding piece component; 41: First additional shielding piece; 41t: Elastic piece; 42: Second additional shielding piece; 42h: Notch;
C: Electrical connector; F: Fastening frame; F1: First mechanical part; F2: Second mechanical part; F3: First fastening piece; F4: Second fastening piece; F5: Third fastening piece; TC: Interconnection electrical connector; P1: First circuit board; P2: Second circuit board;
D1: Distance between shielding pieces; D2: Minimum distance between lead pairs; D3: Minimum distance between leads; D4: Minimum distance between lead and shielding piece; and T: Height direction.

### DESCRIPTION OF EMBODIMENTS

The following describes various example embodiments, features, and aspects of this application in detail with reference to accompanying drawings. Identical reference numerals in the accompanying drawings indicate elements that have same or similar functions. Although various aspects of embodiments are shown in the accompanying drawings, the accompanying drawings are not necessarily drawn in proportion unless otherwise specified.

A specific term “example” herein means “used as an example, an embodiment, or a description”. Any embodiment described as an “example” is not necessarily explained as being superior or better than other embodiments.

In addition, to better describe this application, numerous specific details are given in the following specific embodiments. A person skilled in the art should understand that this application can also be implemented without some specific details. In some embodiments, methods, means, and elements that are well-known to a person skilled in the art are not described in detail, so that a main purpose of this application is highlighted.

In this application, unless otherwise specified, a “height direction” is a height direction of a lead module, which is also consistent with a thickness direction of a shielding piece and a lead in the following example embodiments. However, the height direction should not be understood as a limitation to a use direction or posture of the lead module and an electrical connector of this application.

(Structures of a lead module M and an electrical connector constructed by using the lead module M according to a first example embodiment of this application)

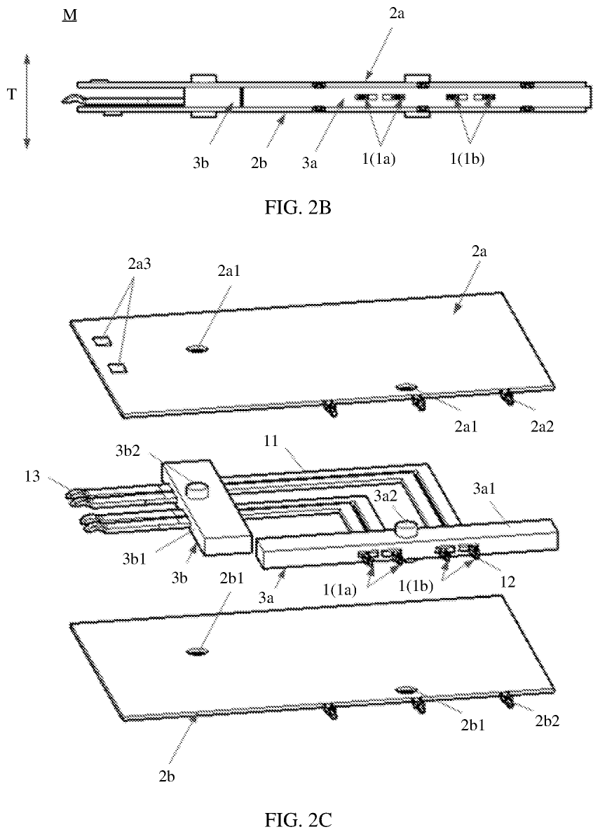

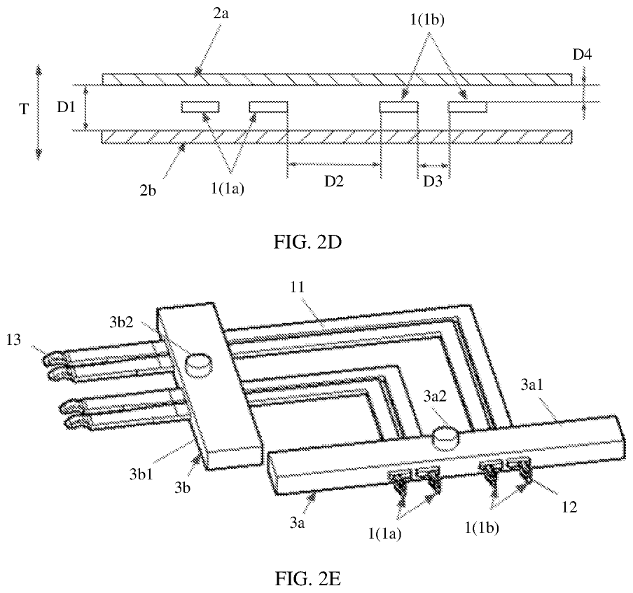

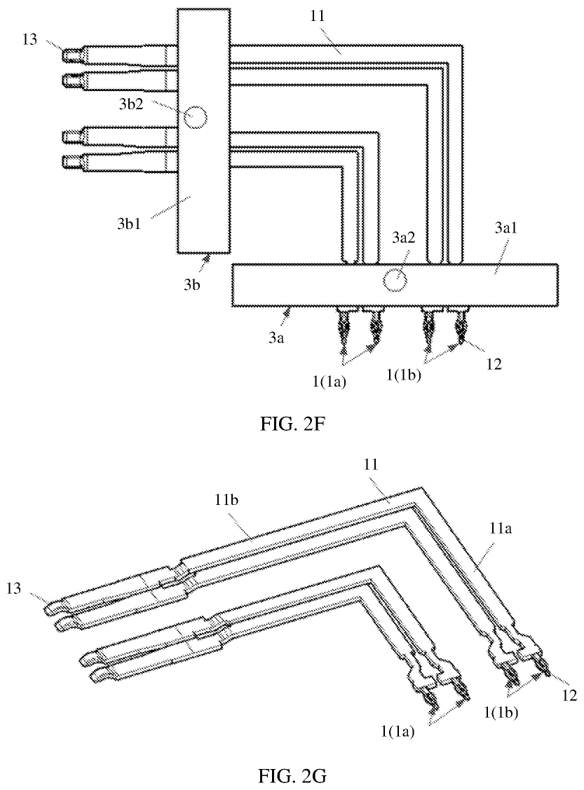

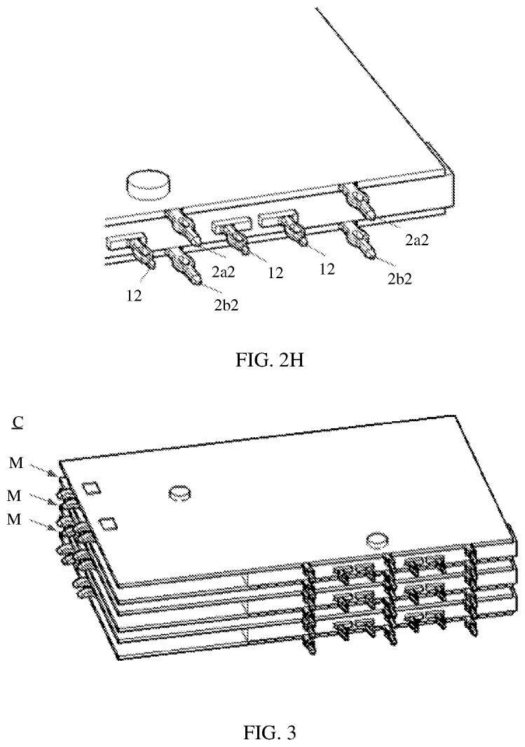

As shown in FIG. 2A to FIG. 2H, a lead module M according to a first example embodiment of this application includes two lead pairs assembled together (including a first lead pair 1a and a second lead pair 1b), two shielding pieces (including a first shielding piece 2a and a second shielding piece 2b), and two fastening members (including a first fastening member 3a and a second fastening member 3b). The two shielding pieces 2a and 2b are parallel to and spaced apart from each other, the two lead pairs 1a and 1b are located between the two shielding pieces 2a and 2b, and the two lead pairs 1a and 1b are fastened relative to the two shielding pieces 2a and 2b by using the two fastening members 3a and 3b.

Specifically, in this embodiment, the two lead pairs 1a and 1b are laid between the two shielding pieces 2a and 2b in a direction perpendicular to a plane in which a surface of the first shielding piece 2a is located (or a plane in which a surface of the second shielding piece 2b is located). The first lead pair 1a and the second lead pair 1b extend parallel (including substantially parallel) to each other. The first lead pair 1a and the second lead pair 1b are always spaced apart by a specific distance during extension.

The first lead pair 1a and the second lead pair 1b each include two leads 1 that are made of a conductive material (for example, metal, in particular phosphor bronze) that are parallel to each other. Each lead 1 is of a flat strip shape, and a thickness direction of each lead 1 is consistent with a height direction T of the lead module M. In a same lead pair 1a or 1b, the two leads 1 are always spaced apart by a specific distance during extension.

Each lead 1 includes a body part 11 completely shielded by the two shielding pieces 2a and 2b, and a pin end part 12 (also referred to as a fisheye part) and a contact end part 13 (also referred to as a spring plate part) located at two ends of the body part 11. A part of the pin end part 12 and a part of the contact end part 13 both protrude from a shielded area of the two shielding pieces 2a and 2b. In this application, the “pin end part 12” of the lead 1 is a part that is of the lead 1 and that is used to electrically connect to wires on a circuit board when the connector including the lead module in this application is disposed on the circuit board, and the “contact end part 13” of the lead 1 is a part that is of the lead 1 and that overlaps leads of an interconnection connector when the connector including the lead module in this application is connected to the interconnection connector so that the lead 1 are electrically connected to the leads of the interconnection connector. For a same lead 1, the pin end part 12 and the contact end part 13 are integrated with the body part 11. Further, in the same lead pair 1a or 1b, pin end parts 12 of all leads 1 form a pin part of the lead pair 1a or 1b, and pin parts of all lead pairs 1a and 1b are arranged together in a predetermined manner, to form a pin part of the lead module M. In addition, in the same lead pair 1a or 1b, contact end parts 13 of all the leads 1 form a contact part of the lead pair 1a or 1b, and contact parts of all the lead pairs 1a and 1b are arranged together in a predetermined manner, to form a contact part of the lead module M.

An angle formed by the pin end part 12 and the contact end part 13 of the lead 1 can be changed by changing an extension direction of the body part 11 of a lead 1, and further, the pin part and the contact part of the lead module M can form at a predetermined angle in this manner. Specifically, in this embodiment, the body part 11 of each lead 1 is bent at 90 degrees once during extension of the body part 11 of each lead 1, and further, each body part 11 includes a first lead segment 11a and a second lead segment 11b that are 90 degrees to each other. Both the first lead segment 11a and the second lead segment 11b extend linearly. Thus, the pin part and the contact part of the lead module M form a predetermined angle of 90 degrees.

Further, in this embodiment, the two shielding pieces 2a and 2b are made of metal (for example, brass or phosphor bronze) and are formed in a rectangular plate shape. The two lead pairs 1a and 1b are sandwiched between the two shielding pieces 2a and 2b. In other words, in the height direction T, the two shielding pieces 2a and 2b are disposed on two sides of the two lead pairs 1a and 1b, to absorb crosstalk radiation of a signal of the lead pairs 1a and 1b during signal transmission.

More specifically, the first shielding piece 2a further has a first mounting hole 2a1 that penetrates in the height direction T, and the second shielding piece 2b further has a second mounting hole 2b1 that penetrates in the height direction T. The mounting holes 2a1 and 2b1 match protrusion parts 3a2 and 3b2 formed by the fastening members 3a and 3b. Therefore, the fastening members 3a and 3b are fastened relative to the shielding pieces 2a and 2b through fit installation between the protrusion parts 3a2 and 3b2 of the fastening members 3a and 3b and the mounting holes 2a1 and 2b1 of the shielding pieces 2a and 2b. Further, a first shielding piece pin part 2a2 is disposed at a part that is of the first shielding piece 2a and that is adjacent to the pin end part 12 of the lead 1, a first shielding piece contact part 2a3 is disposed at a part that is of the first shielding piece 2a and that is adjacent to the contact end part 13 of the lead 1, and a second shielding piece pin part 2b2 is disposed at a part that is of the second shielding piece 2b and that is adjacent to the pin end part 12 of the lead 1. As shown in FIG. 2H, the shielding piece pin parts 2a2 and 2b2 of the first shielding piece 2a and the second shielding piece 2b and pin end parts of the two lead pairs 1a and 1b are alternately arranged in arrangement directions of the shielding piece pin parts 2a2 and 2b2 and the pin end parts of the two lead pairs 1a and 1b, and the first shielding piece pin part 2a2 of the first shielding piece 2a is aligned with the second shielding piece pin part 2b2 of the second shielding piece 2b. The shielding piece pin parts 2a2 and 2b2 of the two shielding pieces 2a and 2b, together with the pin parts of all the lead pairs 1a and 1b, form the pin part of the lead module M, and the first shielding piece contact part 2a3 of the first shielding piece 2a, together with the contact parts of all the lead pairs 1a and 1b, forms the contact part of the lead module M.

Further, in this embodiment, the two fastening members 3a and 3b are made of an insulation material (for example, engineering plastic). The two fastening members 3a and 3b are located between and fastened to the two shielding pieces 2a and 2b, and a part of the lead 1 of each lead pair 1a and 1b is embedded in the fastening members 3a and 3b, so that the two lead pairs 1a and 1b are fastened relative to the two shielding pieces 2a and 2b by using the fastening members 3a and 3b.

More specifically, the first fastening member 3a includes a first body part 3a1 of a cube shape and two first protrusion parts 3a2 integrated with the first body part 3a1, the two first protrusion parts 3a2 respectively protrude from the first body part 3a1 toward the two shielding pieces 2a and 2b, and the two first protrusion parts 3a2 are respectively fitted to the mounting holes 2a1 and 2b1 formed in the two shielding pieces 2a and 2b (for example, fitted together in an interference fit or riveting manner). The second fastening member 3b includes a second body part 3b1 of a cube shape and two second protrusion parts 3b2 integrated with the second body part 3b1, the two second protrusion parts 3b2 respectively protrude from the second body part 3b1 toward the two shielding pieces 2a and 2b, and the two second protrusion parts 3b2 are respectively fitted to the mounting holes 2a1 and 2b1 formed by the two shielding pieces 2a and 2b (for example, fitted together in an interference fit or riveting manner). The first body part 3a1 of the first fastening member 3a and the second body part 3b1 of the second fastening member 3b are arranged between the two shielding pieces 2a and 2b, and a length direction of the first body part 3a1 and a length direction of the second body part 3b1 are perpendicular to each other. Thickness directions of the first body part 3a1 and the second body part 3b1 are consistent with the height direction T of the lead module M. A part that is of the first lead segment 11a of the body part 11 of each lead 1 and that is adjacent to the pin end part 12 is embedded in the first body part 3a1 of the first fastening member 3a, and a part that is of the second lead segment 11b of the body part 11 of each lead 1 and that is adjacent to the contact end part 13 is embedded in the second body part 3b1 of the second fastening member 3b. Therefore, each lead 1 is fastened relative to the two shielding pieces 2a and 2b by using the two fastening members 3a and 3b.

In the lead module M according to the first example embodiment of this application having the foregoing structure, solutions in the following two aspects can be mainly used to effectively suppress crosstalk between the lead pairs 1a and 1b.

On the one hand, no ground wire and another shielding element are disposed between the two shielding pieces 2a and 2b except for the two lead pairs 1a and 1b, and the entire lead module M uses only the two shielding pieces 2a and 2b as the ground wire and the shielding element. Therefore, the lead module M according to the first example embodiment of this application avoids the following problem described in the background, that is, the problem of an increase in the crosstalk between the lead pairs caused by disposing of the ground wire between the lead pairs, so that the crosstalk between the lead pairs is reduced.

On the other hand, exposed parts (exposed to air) that are of the body parts 11 of the leads 1 of the lead pairs 1a and 1b and that are not embedded in the fastening members 3a and 3b and positions of the shielding pieces 2a and 2b are appropriately disposed, to meet specific size requirements, so as to further suppress the crosstalk between the lead pairs 1a and 1b. These size requirements are described below mainly with reference to FIG. 2D. First, it should be noted that, a surface of the exposed part of each lead 1 of the two lead pairs 1a and 1b that faces the first shielding piece 2a is located in a first plane, and a surface of the exposed part of each lead 1 that faces the second shielding piece 2b is located in a second plane. The first plane and the second plane are parallel to the plane in which the first shielding piece 2a is located or the plane in which the second shielding piece 2b is located. Further, in the direction (the height direction T) perpendicular to the plane in which the surface of the first shielding piece 2a is located or the plane in which the surface of the second shielding piece 2b is located, a distance between shielding pieces between the two shielding pieces 2a and 2b is D1. If a minimum distance between lead pairs between exposed parts of two adjacent leads 1 that are respectively located in the two lead pairs 1a and 1b is D2, that D1 is less than D2 is satisfied. For example, when applied to a connector of a router or a connector of a next-generation wavelength division multiplexing system, the distance between shielding pieces D1 preferably satisfies 0.6 mm≤D1<1.1 mm. In addition, the minimum distance between lead pairs D2 preferably satisfies 1.1 mm≤D2≤1.5 mm. In addition, in each lead pair 1a or 1b, a minimum distance between leads between exposed parts of two adjacent leads 1 is D3, and if a minimum distance between lead and shielding piece between the exposed part of each lead 1 among all the leads 1 and an inner surface of the first shielding piece 2a (the inner surface is a surface that is of the first shielding piece 2a and that faces the lead pair 1a and 1b) is D4, that D3 is less than D4 is satisfied. For example, when applied to a connector of a router or a connector of a next-generation wavelength division multiplexing system, the minimum distance between leads D3 preferably satisfies 0.2 mm≤D3<0.25 mm, and the minimum distance between lead and shielding piece D4 preferably satisfies 0.3 mm≤D4≤0.4 mm. In fact, a minimum distance between lead and shielding piece between the exposed part of the lead 1 and the second shielding piece 2b is similar to the minimum distance between lead and shielding piece D4 between the exposed part of the lead 1 and the first shielding piece 2a, also satisfies the foregoing relative relationship with D3, and also preferably satisfies the foregoing value range. With the foregoing size setting, the crosstalk between the lead pairs 1a and 1b can be further suppressed.

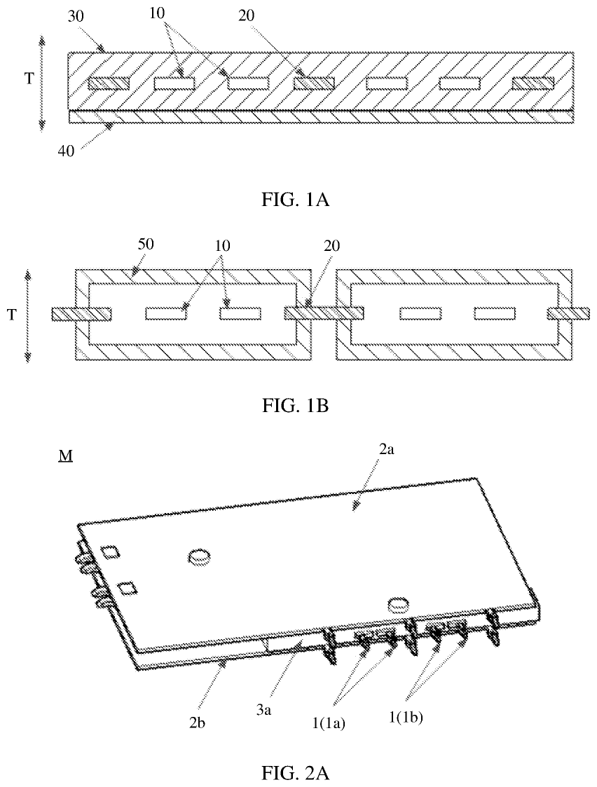

In addition, although not described in the background, in fact, in the electrical connector shown in FIG. 1A, because most of the lead 10 is embedded in the insulator 30, a large insertion loss is generated during signal transmission in this part of the lead 10. According to an insertion loss principle of a high-speed signal, an insertion loss of the signal is related to a loss angle parameter of an insulator (non-metallic material) through which the lead 10 made of metal passes. A loss angle parameter of a non-metallic material (such as plastic) commonly used for the insulator 30 is 0.02, and compared with air with a loss angle parameter of 0.0002, the insulator 30 results in a significant increase in the insertion loss of the signal in the lead 10. If the lead 10 is completely embedded in the insulator 30, the insertion loss of the signal is greatly increased, resulting in severe signal attenuation.

Therefore, in the lead module M according to the first example embodiment of this application having the foregoing structure, to effectively reduce the insertion loss due to the embedding of the lead in the insulator, the following setting is performed. In this embodiment, the body part 11 of each lead 1 includes an embedded part and an exposed part other than the embedded part, and the embedded part is embedded in the fastening members 3a and 3b made of the insulation material. A length of the embedded part is set to be smaller than a length of the exposed part, that is, the length of the exposed part is set to be larger than the length of the embedded part. Through research by the inventor, it is found that if the length of the exposed part is greater than or equal to three times the length of the embedded part, the insertion loss can be effectively reduced, and the length of the exposed part is preferably less than five times the length of the embedded part, so that the lead 1 can be firmly fastened relative to the fastening members 3a and 3b.

In conclusion, the lead module M according to the first example embodiment of this application implements the following effect: The crosstalk between the lead pairs 1a and 1b is effectively suppressed at low costs, and the insertion loss of a signal in the lead 1 is reduced.

An electrical connector C constructed by using the lead module M according to the first example embodiment of this application is described below.

As shown in FIG. 3, three lead modules M according to the first example embodiment of this application are stacked together in a height direction, and shielding pieces 2a and 2b of all the lead modules M are parallel. Pin parts of all the lead modules M together form a pin part of the connector, and contact parts of all the lead modules M together form a contact part of the connector. Because the foregoing effect is implemented in each of the lead modules M, crosstalk and an insertion loss of the entire electrical connector C are effectively reduced.

(Structures of a lead module M and an electrical connector C constructed by using the lead module M according to a second example embodiment of this application)

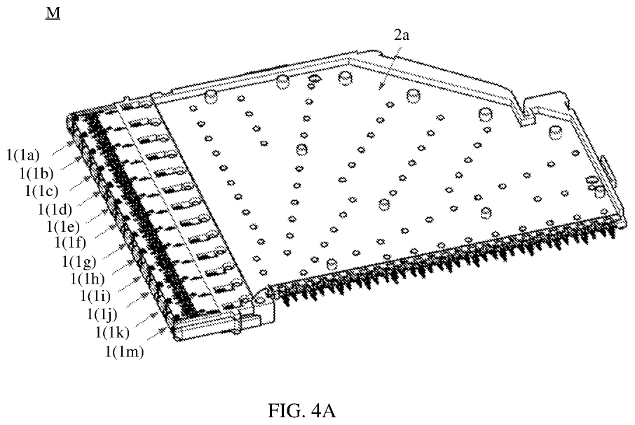

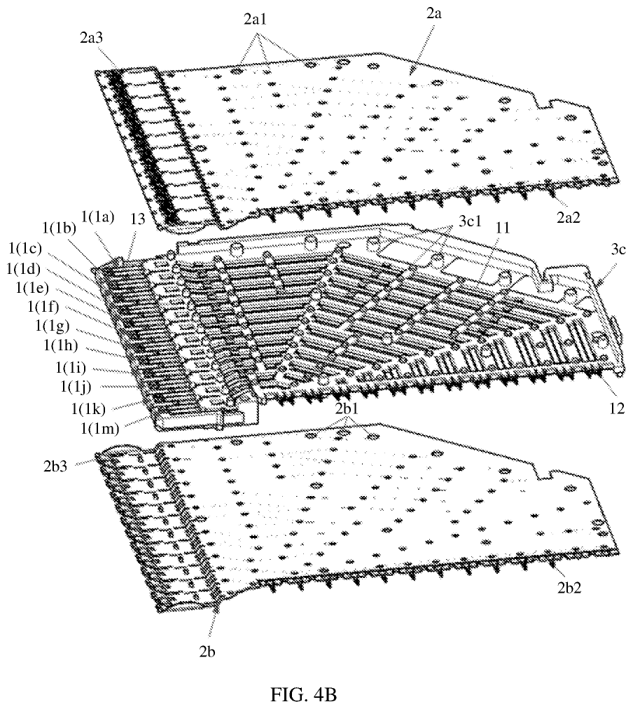

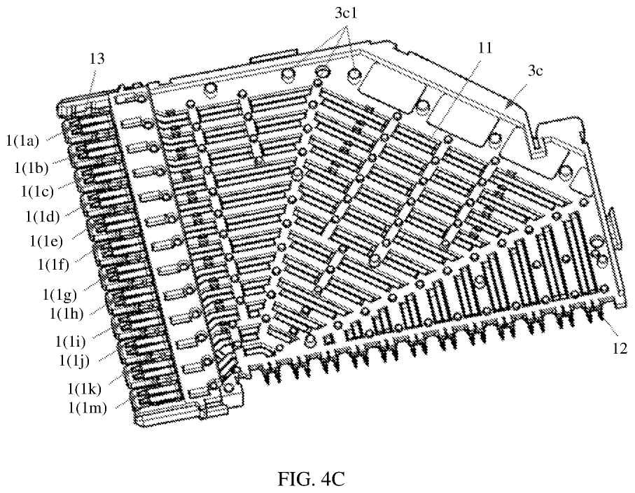

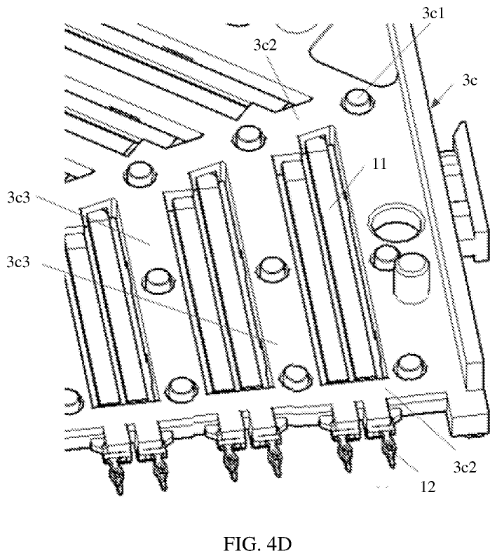

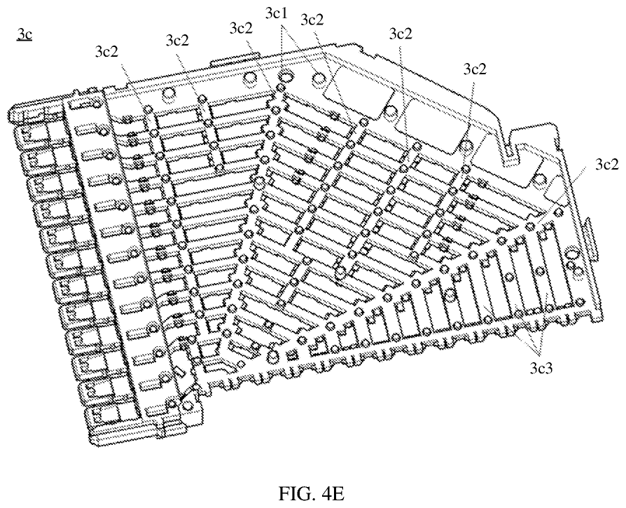

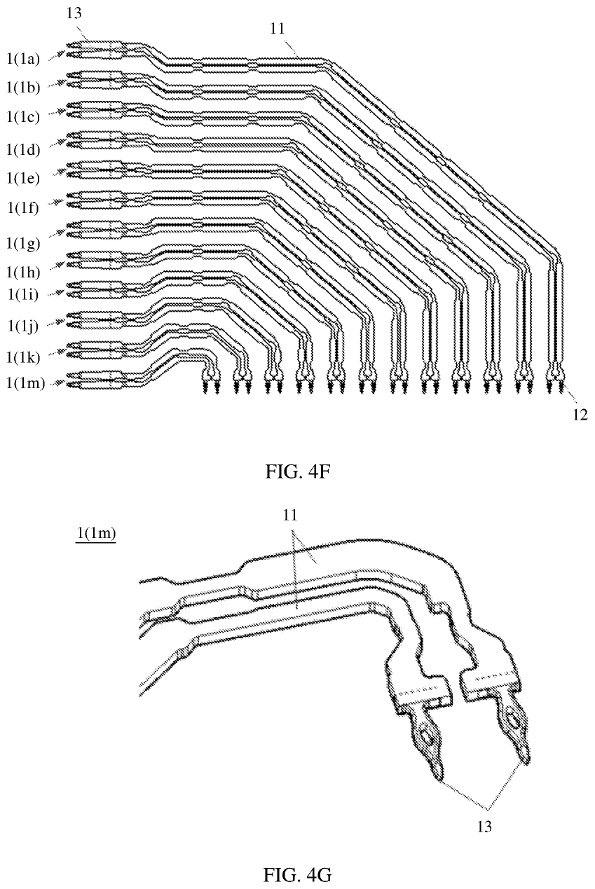

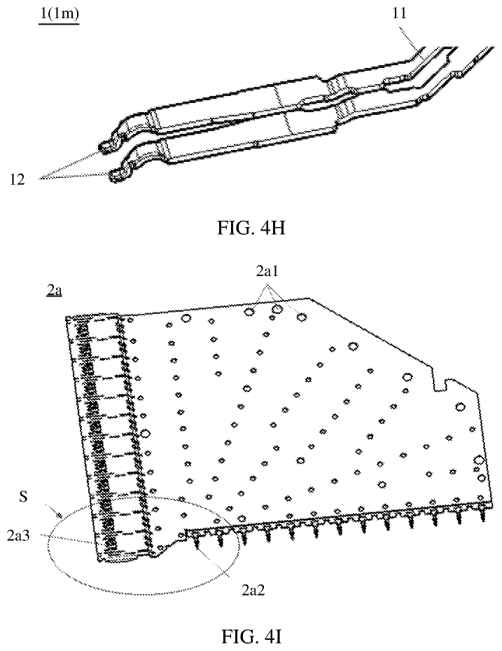

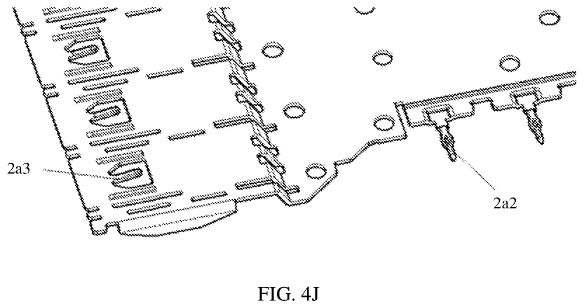

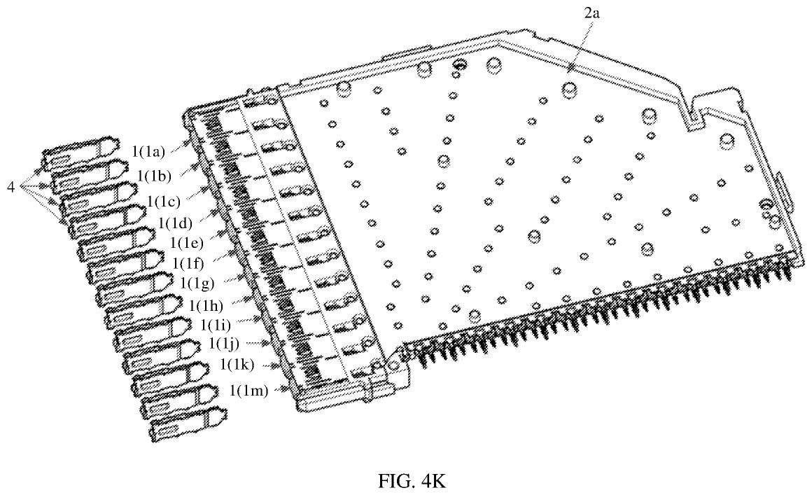

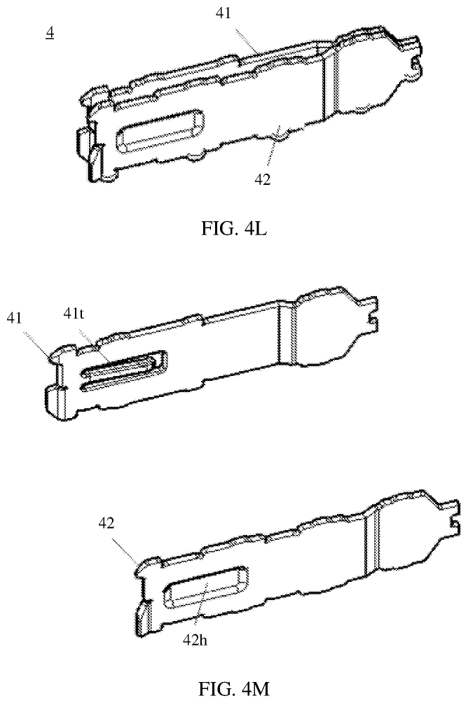

As shown in FIG. 4A to FIG. 4M, a constitution principle of the lead module M according to the second example embodiment of this application is consistent with the constitution principle of the lead module M according to the first example embodiment of this application. Therefore, the same effect as the lead module M according to the first example embodiment of this application can be implemented.

The lead module M according to the second example embodiment of this application includes 12 lead pairs assembled together (including a first lead pair 1a, a second lead pair 1b, a third lead pair 1c, a fourth lead pair 1d, a fifth lead pair 1e, a sixth lead pair 1f, a seventh lead pair 1g, an eighth lead pair 1h, a ninth lead pair 1i, a tenth lead pair 1j, an eleventh lead pair 1k, and a twelfth lead pair 1m), two shielding pieces (including a first shielding piece 2a and a second shielding piece 2b), and an integrated fastening member 3c. The two shielding pieces 2a and 2b are parallel to and spaced apart from each other, the 12 lead pairs 1a to 1m are located between the two shielding pieces 2a and 2b, and the 12 lead pairs 1a to 1m are fastened relative to the two shielding pieces 2a and 2b by using the integrated fastening member 3c.

Specifically, in this embodiment, the 12 lead pairs 1a to 1m are laid between the two shielding pieces 2a and 2b in a direction perpendicular to a plane in which a surface of the first shielding piece 2a is located (or a plane in which a surface of the second shielding piece 2b is located). The 12 lead pairs 1a to 1m extend parallel to each other. Every two adjacent lead pairs in the 12 lead pairs 1a to 1m are always spaced apart by a specific distance during extension.

Lead pairs 1a to 1m each include two leads 1 that are made of a conductive material (for example, metal, in particular phosphor bronze) that are parallel to each other. Each lead 1 is of a flat strip shape, and a thickness direction of each lead 1 is consistent with a height direction of the lead module M. In each of the lead pairs 1a to 1m, two leads 1 are always spaced apart by a specific distance during extension.

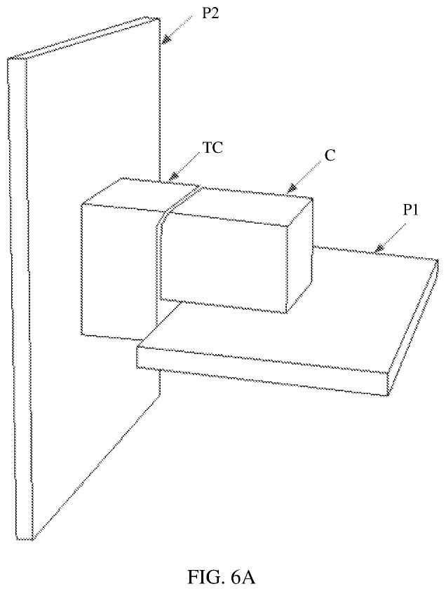

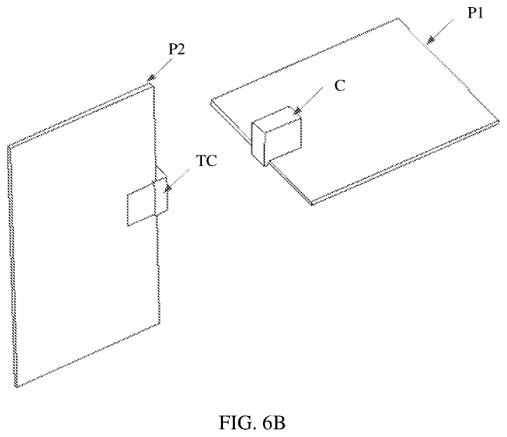

Each lead 1 includes a body part 11 completely shielded by the two shielding pieces 2a and 2b, and a pin end part 12 (also called a fisheye part) and a contact end part 13 (also called a spring plate part) located at two ends of the body part 11. A part of the contact end part 13 has a protrusion part, to elastically connect to a corresponding contact part of an interconnection electrical connector TC (refer to FIG. 6A and FIG. 6B). For a same lead 1, the pin end part 12 and the contact end part 13 are integrated with the body part 11. Further, in each of the lead pairs 1a to 1m, pin end parts 12 of the leads 1 form a pin part of each of the lead pairs 1a to 1m, and pin parts of all lead pairs 1a to 1m are arranged together in a predetermined manner, to form a pin part of the lead module M. In addition, in each of the lead pairs 1a to 1m, contact end parts 13 of the leads 1 form a contact part of each of the lead pairs 1a to 1m, and contact parts of all the lead pairs 1a to 1m are arranged together in a predetermined manner, to form a contact part of the lead module M.

An angle formed by the pin end part 12 and the contact end part 13 of the lead 1 can be changed by changing an extension direction of the body part 11 of a lead 1, and further, the pin part and the contact part of the lead module M can be formed at a predetermined angle in this manner. Specifically, in this embodiment, the body part 11 of each lead 1 is bent a plurality of times during extension of the body part 11 of each lead 1, and further, each body part 11 includes a plurality of linear parts forming a predetermined angle between each other. Finally, a predetermined angle of 90 degrees is formed between the pin part and the contact part of the lead module M.

Further, in this embodiment, the two shielding pieces 2a and 2b are made of metal (for example, brass or phosphor bronze) and are formed in a plate shape. The two shielding pieces 2a and 2b are disposed on two sides of all the lead pairs 1a to 1m in a manner of sandwiching all the lead pairs 1a to 1m, to absorb crosstalk radiation of a signal of the lead pairs 1a to 1m during signal transmission.

More specifically, the first shielding piece 2a further has a large quantity of first mounting holes 2a1 that penetrate in a height direction T, and the second shielding piece 2b further has a large quantity of second mounting holes 2b1 that penetrate in the height direction T. The mounting holes 2a1 and 2b1 match protrusion parts 3c1 formed by the integrated fastening member 3c. Therefore, the fastening member 3c is fastened relative to the shielding pieces 2a and 2b through fit installation between the protrusion parts 3c1 of the integrated fastening member 3c and the mounting holes 2a1 and 2b1 of the shielding pieces 2a and 2b. Further, a first shielding piece pin part 2a2 is disposed at a part that is of the first shielding piece 2a and that is adjacent to the pin end part 12 of the lead 1, a first shielding piece contact part 2a3 is disposed at a part that is of the first shielding piece 2a and that is adjacent to the contact end part 13 of the lead 1, a second shielding piece pin part 2b2 is disposed at a part that is of the second shielding piece 2b and that is adjacent to the pin end part 12 of the lead 1, and a second shielding piece contact part 2b3 is disposed at a part that is of the second shielding piece 2b and that is adjacent to the contact end part 13 of the lead 1. The shielding piece contact parts 2a3 and 2b3 have elastic protrusion parts. As shown in FIG. 4K, the shielding piece pin parts 2a2 and 2b2 of the first shielding piece 2a and the second shielding piece 2b and pin end parts of the lead pairs 1a to 1m are alternately arranged in arrangement directions of the shielding piece pin parts 2a2 and 2b2 and the pin end parts of the lead pairs 1a to 1m, and the first shielding piece pin part 2a2 of the first shielding piece 2a is aligned with the second shielding piece pin part 2b2 of the second shielding piece 2b. The shielding piece pin parts 2a2 and 2b2 of the two shielding pieces 2a and 2b, together with the pin parts of all the lead pairs 1a to 1m, form the pin part of the lead module M, and the shielding piece contact parts 2a3 and 2b3 of the two shielding pieces 2a and 2b, together with the contact parts of all the lead pairs 1a to 1m, form the contact part of the lead module M.

Further, in this embodiment, the integrated fastening member 3c is made of an insulation material (for example, engineering plastic, for example, a liquid crystal polymer LCP). The integrated fastening member 3c is located between and fastened to the two shielding pieces 2a and 2b, and a part of the lead 1 of each of the lead pairs 1a to 1m is embedded in the integrated fastening member 3c, so that all the lead pairs 1a to 1m are fastened relative to the two shielding pieces 2a and 2b by using the integrated fastening member 3c.

More specifically, the integrated fastening member 3c has a large quantity of protrusion parts 3c1 corresponding to the mounting holes 2a1 and 2b1 of the two shielding pieces 2a and 2b, and these protrusion parts 3c1 protrude toward the two shielding pieces 2a and 2b respectively. The integrated fastening member 3c has a plurality of horizontal rib parts 3c2 and a plurality of vertical rib parts 3c3, the plurality of horizontal rib parts 3c2 extend in a direction perpendicular to the lead pairs 1a to 1m, and the plurality of vertical rib parts 3c3 extend substantially parallel to the lead pairs 1a to 1m. Therefore, the plurality of horizontal rib parts 3c2 and the plurality of vertical rib parts 3c3 are disposed to cross each other. Grooves for mounting the leads 1 of the lead pairs 1a to 1m are formed between adjacent vertical rib parts 3c3 and between the vertical rib parts 3c3 and a frame of the integrated fastening member 3c, embedded parts of the body parts 11 of the leads 1 of the lead pairs 1a to 1m disposed in these grooves are embedded in the horizontal rib parts 3c2, the body parts 11 extend through the horizontal rib parts 3c2, and exposed parts of the body parts 11 of the leads 1 that are not embedded in the horizontal rib parts 3c2 are exposed to air. In addition, in the integrated fastening member 3c, some protrusion parts 3c1 are disposed at intersections of the horizontal rib parts 3c2 and the vertical rib parts 3c3, and other protrusion parts 3c1 are disposed on the frame of the integrated fastening member 3c. Assemblies of the integrated fastening member 3c and the lead pairs 1a to 1m can be formed through high-temperature injection molding by using a mold.

Further, in this embodiment, the lead module M further includes a plurality of additional shielding piece components 4. Each additional shielding piece component 4 includes a first additional shielding piece 41 and a second additional shielding piece 42 disposed side by side, the first additional shielding piece 41 has an elastic piece 41t, and the second additional shielding piece 42 has a notch 42h corresponding to the elastic piece 41t. Each additional shielding piece component 4 is inserted between the two shielding pieces 2a and 2b in an upright manner, and each additional shielding piece component 4 is fastened together with the shielding pieces 2a and 2b, for example, by welding. A total of 13 additional shielding piece components 4 are alternately arranged with the contact parts of the lead pairs 1a to 1m, so that the additional shielding piece component 4 is disposed on two sides of the contact part of any lead pair 1a to 1m.

Refer to, for example, FIG. 4F and FIG. 4K. It can be seen that a length of the additional shielding piece component 4 is obviously less than a length of the lead 1. For example, for a shortest lead 1, the length of the additional shielding piece component 4 is less than half a length of the shortest lead 1, and for a longest lead 1, for example, the length of the additional shielding piece component 4 is less than ⅙ or ⅛ of a length of the longest lead 1.

The foregoing structure is used, and on the one hand, in the lead module M according to the second example embodiment of this application having the foregoing structure, although the additional shielding piece component 4 is disposed between contact parts of adjacent lead pairs, another ground wire or shielding element is no longer disposed between the body parts of the leads of the adjacent lead pairs, to reduce crosstalk caused by disposing of the another ground wire or shielding element between the lead pairs 1a to 1m. On the other hand, size relationships in this embodiment meet the requirements on the distance between shielding pieces D1, the minimum distance between lead pairs D2, the minimum distance between leads D3, and the minimum distance between lead and shielding piece D4 described in the lead module M of the first example embodiment. Therefore, crosstalk between the lead pairs 1a to 1m is effectively suppressed as in the first embodiment. Further, in this embodiment, in the lead pairs 1a to 1m, a length of the exposed part of the body part 11 of each lead 1 is much larger than a length of the embedded part, and thus an insertion loss of the lead 1 is greatly reduced as in the first embodiment.

An electrical connector C constructed by using the lead module M according to the second example embodiment of this application is described below.

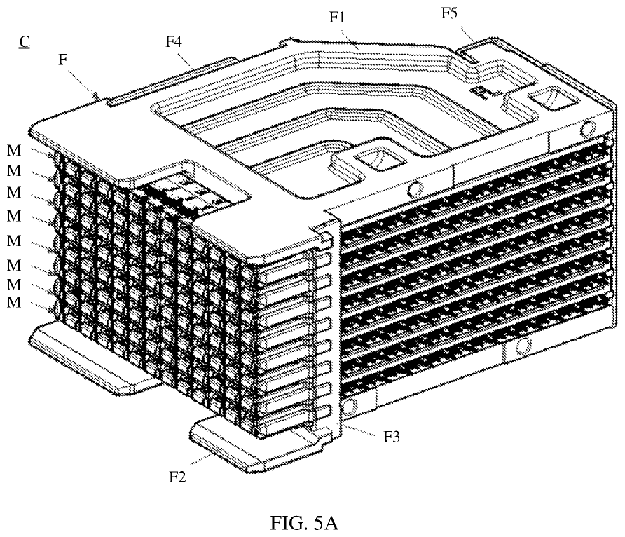

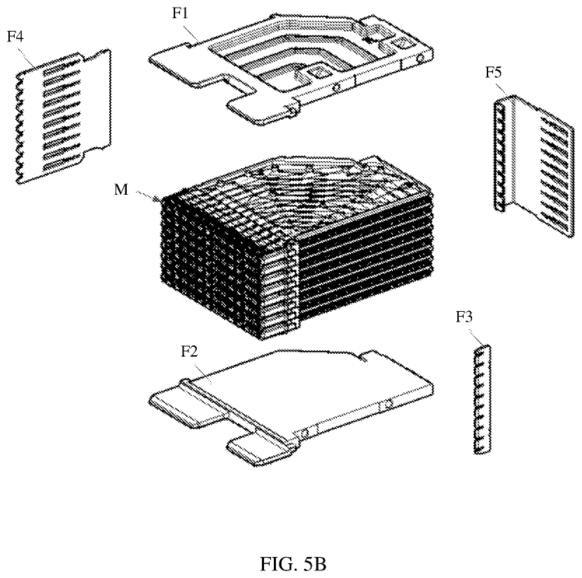

As shown in FIG. 5A and FIG. 5B, eight lead modules M according to the second example embodiment of this application are stacked together in a height direction, and shielding pieces 2a and 2b of all the lead modules M are parallel. Pin parts of all the lead modules M together form a pin part of the connector, and all the pin parts are arranged in a matrix manner. Contact parts of all the lead modules M together form a contact part of the connector, and all the contact parts are arranged in a matrix manner. Therefore, because a total of eight lead modules M are disposed and each lead module M has 12 lead pairs 1a to 1m, the electrical connector C can transmit a total of ninety-six pairs (high speed) of signals. Because the foregoing effect is implemented in each of the lead modules M, crosstalk and an insertion loss of the entire electrical connector C are effectively reduced.

Further, to make the plurality of lead modules M fastened, the electrical connector C further includes a fastening frame F, and the fastening frame F and the plurality of lead modules M are assembled and fastened together. Specifically, the fastening frame F includes a first mechanical part F1, a second mechanical part F2, a first fastening piece F3, a second fastening piece F4, and a third fastening piece F5. All the lead modules M are sandwiched between the first mechanical part F1 and the second mechanical part F2, and the first mechanical part F1 and the second mechanical part F2 hold, from two sides in the height direction, the lead modules M stacked together. Each of the first fastening piece F3 and the second fastening piece F4 has a plate structure, and each of the first fastening piece F3 and the second fastening piece F4 has a plurality of clamping parts corresponding to the first mechanical part F1, the second mechanical part F2, and the integrated fastening member 3c of each lead module M. The third fastening piece F5 forms a fold-back structure that matches corresponding parts of the first mechanical part F1, the second mechanical part F2, and the lead modules M, so that the third fastening piece F5 can be clamped together with the corresponding parts as shown in the figure. The fold-back part of the third fastening piece F5 also has a plurality of clamping parts corresponding to the first mechanical part F1, the second mechanical part F2, and the integrated fastening member 3c of each lead module M. The first fastening piece F3, the second fastening piece F4, and the third fastening piece F5 are clamped together with the first mechanical part F1, the second mechanical part F2, and the integrated fastening member 3c of each lead module M by using the clamping parts of the first fastening piece F3, the second fastening piece F4, and the third fastening piece F5, which ensures structural stability of the entire electrical connector C in space.

The following describes a specific structure of a connector component by using the foregoing electrical connector C with reference to the accompanying drawings of the specification.

(Structure of a connector component according to example embodiments of this application)

As shown in FIG. 6A, a connector component according to an example embodiment of this application may be referred to as a back plug-in connector component, and the connector component includes an electrical connector C having the foregoing structure and an interconnection electrical connector TC capable of matching and being connected to the electrical connector C. The electrical connector C is disposed at a substantially central part of a first circuit board P1, and the interconnection electrical connector TC is disposed at a peripheral part of a second circuit board P2. Therefore, when the electrical connector C and the interconnection electrical connector TC are plugged and connected to each other, the first circuit board P1 and the second circuit board P2 are perpendicular in a manner shown in the figure.

As shown in FIG. 6B, a connector component according to another example embodiment of this application may be referred to as a horizontal plug-in connector component, and the connector component includes an electrical connector C having the foregoing structure and an interconnection electrical connector TC capable of matching and being connected to the electrical connector C. The electrical connector C is disposed at a peripheral part of a first circuit board P1 (horizontal plug-in board), and the interconnection electrical connector TC is disposed at a peripheral part of a second circuit board P2 (vertical plug-in board). Therefore, when the electrical connector C and the interconnection electrical connector TC are plugged and connected to each other, the first circuit board P1 and the second circuit board P2 are perpendicular in a manner shown in the figure. Further, if a plurality of electrical connectors C are disposed on the horizontal plug-in board and a plurality of corresponding interconnection electrical connectors TC are disposed on the vertical plug-in board, a product information exchange system with a strong information transmission capability can be formed when a plurality of such horizontal plug-in boards and vertical plug-in boards are used.

In addition, whether the board-to-board connector component shown in FIG. 6A or FIG. 6B is used, after the electrical connector C and the interconnection electrical connector TC are connected, the connector component can implement high-speed signal transmission at a rate of at least 56 Gbps. Preferably, the connector component can implement a rate of 56 Gbps or 112 Gbps, and is therefore suitable for devices that require high-speed signal transmission, such as a switch and a router.

The example embodiments and related modifications of the specific implementations of this application are described in the foregoing content, and supplementary descriptions are provided below.

i. Although the shielding pieces 2a and 2b are made of the conductive metal material as described in the foregoing specific implementations, this application is not limited thereto, and the shielding pieces 2a and 2b may be made of the conductive material in parts and a non-conductive material in other parts. That is, the shielding pieces 2a and 2b only need to include the conductive material such as the metal to implement a shielding function. For example, the shielding piece may be formed by compounding a conductive layer and a non-conductive layer (for example, a plastic layer), or a metal coating layer and a metal plating layer may be disposed on the non-conductive material layer.

ii. Although it is described in the foregoing specific implementations that the fastening member has the protrusion part and the shielding piece has the mounting hole, and the fastening member is fastened relative to the shielding piece through fit installation between the protrusion part and the mounting hole, this application is not limited thereto. For example, the fastening member may have the mounting hole and the shielding piece has the protrusion part corresponding to the mounting hole. The fastening member is fastened relative to the shielding piece through fit installation between the mounting hole of the fastening member and the protrusion part of the shielding piece.

iii. It may be understood that, in the embodiments described in the foregoing specific implementations, in the height direction, distances between the body part (especially the exposed part) of each lead and the two shielding pieces may be substantially equal, or may not be equal. That is, the distance between the body part and the two shielding pieces may be set based on an actual need.

iv. Although not described in the foregoing specific implementations, it may be understood that in the electrical connector C according to this application, adjacent lead modules M may share one shielding piece.

v. The inventor of this application learns through an experiment that crosstalk of the electrical connector using the structure in FIG. 1A reaches −45 dB at 35 GHz, and crosstalk of the electrical connector using the structure in this application within a range of 0-60 GHz may reach −55 dB. In addition, an insertion loss of the electrical connector using the structure in FIG. 1A at 29 GHz has reached −2.65 dB, and signal attenuation is serious. However, an insertion loss of the electrical connector using the structure of this application is only −1.47 dB at 29 GHz, and therefore, by comparison, a signal attenuation degree is greatly reduced.

vi. It should be understood that the lead module M and the electrical connector C and the connector component that are constructed by the lead module M in this application implement the effect of effectively reducing the crosstalk and the insertion loss with a simple shielding structure, improve structural reliability of the device, reduce manufacturing costs, and facilitate large-scale industrial production.

vii. In this application, using a first solution and a second solution connected by “and/or” means that both the first solution and the second solution may be used, or either the first solution or the second solution may be used. For example, 0.6 mm≤D1<1.1 mm; and/or 1.1 mm≤D2≤1.5 mm are/is defined in this application, which means that this application includes a solution using only 0.6 mm≤D1<1.1 mm, further includes a solution using only 1.1 mm≤D2≤1.5 mm, and further includes a solution using 0.6 mm≤D1<1.1 mm and 1.1 mm≤D2≤1.5 mm.

Although this application is described with reference to the embodiments, in a process of implementing this application that claims protection, a person skilled in the art may understand and implement another variation of the disclosed embodiments by viewing the accompanying drawings, disclosed content, and the appended claims. In the claims, “comprising” does not exclude another component or another step, and “a” or “one” does not exclude a case of plurality. Some measures are recorded in dependent claims that are different from each other, but this does not mean that these measures cannot be combined to produce better effect.

Embodiments of this application are described above. The foregoing descriptions are examples, are not exhaustive, and are not limited to the disclosed embodiments. Many modifications and variations are apparent to a person of ordinary skill in the art without departing from the scope and spirit of the described embodiments. Selection of terms used in this specification is intended to best explain embodiment principles, actual application, or improvements to technologies in the market, or to enable another person of ordinary skill in the art to understand the embodiments disclosed in this specification.

What is claimed is:

1. A lead module, comprising:
a plurality of lead pairs, wherein each lead pair comprises two leads parallel to each other, two adjacent lead pairs are spaced apart by a predetermined distance, each lead comprises a pin end part, a contact end part, and a body part, and the body part is between the pin end part and the contact end part; and
two shielding pieces, wherein the two shielding pieces each comprise a conductive material, the two shielding pieces are parallel to each other, the plurality of lead pairs are sandwiched between the two shielding pieces, and the plurality of lead pairs are fastened relative to the two shielding pieces.

2. The lead module according to claim 1, wherein the plurality of lead pairs are laid between the two shielding pieces in a direction perpendicular to a surface of either of the two shielding pieces.

3. The lead module according to claim 2, wherein the lead module further comprises at least one fastening member made of a non-conductive insulation material, the fastening member is located between the two shielding pieces and fastened to the two shielding pieces, and a part of the body part of each lead is embedded in the fastening member, so that the plurality of lead pairs are fastened relative to the two shielding pieces by using the fastening member.

4. The lead module according to claim 3, wherein in the plurality of lead pairs, the body part of each lead comprises an embedded part embedded in the fastening member and an exposed part other than the embedded part, so that in the plurality of lead pairs, at least a part of a surface that is of each exposed part and that faces a same shielding piece is located in a first plane, and the first plane is parallel to a plane in which a surface of either of the two shielding pieces is located.

5. The lead module according to claim 4, wherein in the direction perpendicular to a surface of either of the two shielding pieces, distances between the exposed parts of all leads and each of the two shielding pieces are equal.

6. The lead module according to claim 4, wherein in the direction perpendicular to a surface of either of the two shielding pieces, a spacing between the two shielding pieces is D1, and in two adjacent lead pairs, if a minimum distance between exposed parts of two adjacent leads that are respectively located in different lead pairs is D2, D1<D2 is satisfied.

7. The lead module according to claim 6, wherein 0.6 mm≤D1<1.1 mm; and/or 1.1 mm≤D2≤1.5 mm.

8. The lead module according to claim 4, wherein in each lead pair, a minimum distance between exposed parts of two leads is D3, and if a minimum distance between the exposed part of each lead and an inner surface of either of the two shielding pieces is D4, D3<D4 is satisfied.

9. The lead module according to claim 8, wherein 0.2 mm≤D3<0.25 mm; and/or 0.3 mm≤D4≤0.4 mm.

10. The lead module according to claim 4, wherein for each lead, a length of the exposed part is greater than a length of the embedded part.

11. The lead module according to claim 10, wherein for each lead, the length of the exposed part is greater than or equal to three times the length of the embedded part.

12. The lead module according to claim 3, wherein
the fastening member has protrusion parts protruding toward the two shielding pieces, the two shielding pieces each have a mounting hole matching the protrusion part, and the fastening member is mounted and fastened to the two shielding pieces through fit installation between the protrusion parts and the mounting holes; or
the two shielding pieces each have a protrusion part protruding toward the fastening member, the fastening member has a mounting hole matching the protrusion parts, and the fastening member is mounted and fastened to the two shielding pieces through fit installation between the protrusion parts and the mounting holes.

13. An electrical connector, comprising one or more lead modules, comprising:
a plurality of lead pairs, wherein each lead pair comprises two leads parallel to each other, two adjacent lead pairs are spaced apart by a predetermined distance, each lead comprises a pin end part, a contact end part, and a body part, and the body part is between the pin end part and the contact end part; and
two shielding pieces, wherein the two shielding pieces each comprise a conductive material, the two shielding pieces are parallel to each other, the plurality of lead pairs are sandwiched between the two shielding pieces, and the plurality of lead pairs are fastened relative to the two shielding pieces.

14. The electrical connector according to claim 13, wherein the plurality of lead modules are arranged in a stacked manner in which shielding pieces of all the lead modules are parallel.

15. The electrical connector according to claim 14, wherein pin parts of all the lead modules are arranged in a matrix manner, to form a pin part of the connector; and contact parts of all the lead modules are arranged in a matrix manner, to form a contact part of the connector.

16. The electrical connector according to claim 14, wherein adjacent lead modules share one shielding piece.

17. The electrical connector according to claim 13, wherein the electrical connector further comprises a fastening frame, and the fastening frame is assembled with the plurality of lead modules, so that the plurality of the lead modules are relatively fastened.

18. A connector component, comprising the electrical connector according to claim 13 and an interconnection electrical connector capable of matching and being connected to the electrical connector.

19. The connector component according to claim 18, wherein the electrical connector and the interconnection electrical connector are respectively disposed on two circuit boards disposed perpendicularly to each other.

20. The connector component according to claim 18, wherein after the electrical connector and the interconnection electrical connector are connected, the connector component can implement signal transmission at a rate of at least 56 Gbit/s.
